(19) United States
(12) Patent Application Publication
(10) Pub. No.: US 2021/0180312 A1
(43) Pub. Date: Jun. 17, 2021

(54) RECTANGULAR EXTRUSION CONNECTOR

(71) Applicant: Philip DiTrolio, Suwanee, GA (US)

(72) Inventor: Philip DiTrolio, Suwanee, GA (US)

(21) Appl. No.: 17/188,230

(22) Filed: Mar. 1, 2021

Related U.S. Application Data
(63) Continuation-in-part of application No. 15/727,695, filed on Oct. 9, 2017, now Pat. No. 10,941,560.
Application No. 15/727,695 is a continuation-in-part of application No. 29/739,477, filed on Jun. 25, 2020.
(60) Provisional application No. 62/417,121, filed on Nov. 3, 2016.
(60) Provisional application No. 62/984,196, filed on Mar. 2, 2020.

(51) Int. Cl. E04B 1/24; A47H 1/02; A47H 1/102; E04H 1/12

(52) U.S. Cl. CPC E04B 1/2403; A47H 1/02; E04B 2001/2409; E04H 1/1272; A47H 1/102

(57) ABSTRACT

The coupler adaptor mounts on a rectangular extrusion vertical end to allow one or more accessory connections to be affixed to the vertical rectangular extrusion. A further object is to allow multiple horizontal rods to be mounted in parallel from a single vertical rectangular extrusion. The coupler adaptor clamps onto the vertically configured rectangular extrusion via a stable clamp and a slidable clamp. The slidable clamp and the stable clamp are pulled together along the length of the coupler adaptor body via the screw tightener. The channel openings and the channel walls are mated with the grooves on the rectangular extrusion creating a clamped, friction mating with the rectangular extrusion such that the coupler adaptor is securely fastened to the rectangular extrusion.

### CROSS-REFERENCE TO RELATED APPLICATIONS

This application is a continuation-in-part of and claims priority to U.S. application Ser. No. 15/727,695, filed Oct. 9, 2017, and entitled “Connector for Pipes” which claims priority to U.S. Provisional Patent Application No. 62/417,121, filed Nov. 3, 2016, and entitled “Coupler for Pipes.” This application also claims priority to U.S. Provisional Application No. 62/984,196, filed Mar. 2, 2020, and entitled “Rectangular Extrusion Connector.” This application is also a continuation-in-part of and claims priority to U.S. Design Application No. 29/739,477 filed Jun. 25, 2020 and entitled “Connector Accessory for Pipes.” The entire contents of the above-identified applications are hereby fully incorporated herein by reference.

### FIELD OF INVENTION

The present invention relates to couplers for drape rods of the type typically found in exhibit booths. In even greater particularity, the present invention relates to a coupler adaptor to affix to a rectangular extrusion tube to allow accessories to be mounted.

### BACKGROUND

In the prior art, exhibit booths and the like are constructed using a rectangular tube framework supporting drapes as walls and or covers. Many of these booths are constructed using hook-and-slot systems, which utilize upright aluminum tubes with slots formed near the top regions thereof for receiving hooks secured to and extending from the ends of horizontal tubular rods. Draping material is placed over the horizontal rods to form booths or partitions as may be required. Pipe and drape walls traditionally have a “bumpy” appearance due to the height difference of the vertical members in relation to the top of horizontally disposed connecting rods. Additionally, the steel hooks on industry standard horizontal drape rods have a tendency toward “tearing” the aluminum vertical uprights in a “can opener” effect when the steel hooks are inserted in the existing slots in the uprights. Past attempts to solve these problems involve proprietary connectors that are not compatible with the standard steel hooks.

### SUMMARY OF THE INVENTION

An object of the invention is to enable the industry standard hooks on horizontal rods and other accessories to rest at such a height as to provide uniform appearance to the top of drape walls. A further object is to allow a coupler adaptor to mount on a rectangular extrusion end to allow one or more accessory connections to be affixed to the vertical rectangular extrusion. A further object is to allow multiple horizontal rods to be mounted in parallel from a single vertical rectangular extrusion. The coupler adaptor clamps onto the vertically configured rectangular extrusion via a stable clamp and a slidable clamp. The slidable clamp and the stable clamp are pulled together along the length of a coupler adaptor body via a screw tightener. Channel openings and channel walls on the coupler adaptor are mated with the grooves on the rectangular extrusion creating a clamped, friction mating with the rectangular extrusion such that the coupler adaptor is securely fastened to the rectangular extrusion.

A further object is to prevent the steel hooks on industry standard horizontal drape rods from “tearing” into the support pipes or extrusion tubes. Yet another object of the invention is to affix accessories for the industry standard hooks to be inserted at a wider angle of insertion and to allow easier connection as compared to the narrow industry standard slots. A still further object of the invention is to accomplish the foregoing objects using industry standard fasteners or hooks.

These and other aspects, objects, features, and advantages of the example embodiments will become apparent to those having ordinary skill in the art upon consideration of the following detailed description of illustrated example embodiments.

### BRIEF DESCRIPTION OF THE DRAWINGS

Referring to the drawings, which are appended hereto and which form a portion of this disclosure, it may be seen that:

FIG. 1 is a perspective view of one embodiment of a coupler adaptor.

FIG. 2 is a top plan view of one embodiment of the coupler adaptor.

FIG. 3 is a perspective view of one embodiment of the coupler adaptor.

FIG. 4 is a side view of one embodiment of the coupler adaptor.

FIG. 5 is a side view of one embodiment of the coupler adaptor.

FIG. 6 is a perspective view of one embodiment of the coupler adaptor attached to a rectangular extrusion.

FIG. 7 is a perspective view of one embodiment of a coupler.

FIG. 8 is a perspective view of one embodiment of the coupler adaptor attached to a rectangular extrusion with a flat-mounted coupler.

### DETAILED DESCRIPTION

The example embodiments described herein provide a coupler adaptor 40 that supports a flat-mounted coupler 10 for connecting substantially orthogonally disposed rods to vertical rectangular extrusions in a pipe and drape exhibit booth construction. The “Pipe and Drape” industry, is a subset of exhibition and convention services in which frameworks are constructed from horizontally and vertically disposed members in such a fashion to allow draperies or curtains to hang and create division of space in convention halls or other similar areas by arranging drapery walls and booths. The coupler accessory 11, such as a castletop coupler, is designed to provide an improvement to form and function over the industry standard hook and slot technology, yet allowing users of existing systems to continue using their inventory of components.

The coupler adaptor 40 allows accessories, such as flat-mounted coupler 10, to be affixed to the sidewall or end of the rectangular extrusion. The rectangular extrusion may be an extruded or otherwise formed member that is used as a frame for the pipe and drape assembly. The rectangular extrusion may be a linear tube that has a substantially rectangular cross section. For example, the rectangular extrusion may be any functional length, such as 2, 4, 8, 12, or 20 feet long. The cross-sectional dimensions of the rectangular extrusion may be any suitable size, such as 1 inch by 2 inches, 2 inches by 4 inches, 4 inches by 4 inches, or any other suitable size. The rectangular extrusion may include grooves, slots, channels, or any other suitable opening at two or more corners to allow accessories to be mounted to the rectangular extrusion. Throughout the specification, the openings will be referred to as “grooves.” The grooves may allow any type of clamp or other connection mechanism to grip onto the rectangular extrusion for mounting. The grooves may be an industry standard groove pattern for rectangular extrusions in the pipe and drape industry.

Various accessories might allow a flat-mounted coupler 10 to be affixed to the coupler adaptor 40 in an offset position. For example, a flat-mounted coupler 10 may be affixed to the coupler adaptor 40. The accessories might allow a second and third coupler be affixed to the first coupler accessory 11 in offset positions to allow additional rods to be vertically supported. The coupler adaptor 40 allows additional rods to be connected to the top of a single vertical rectangular extrusion. In examples herein, when one coupler accessory 11 is being described, other examples that include two or more coupler accessories 11 in any configuration may be envisioned to operate substantially similarly.

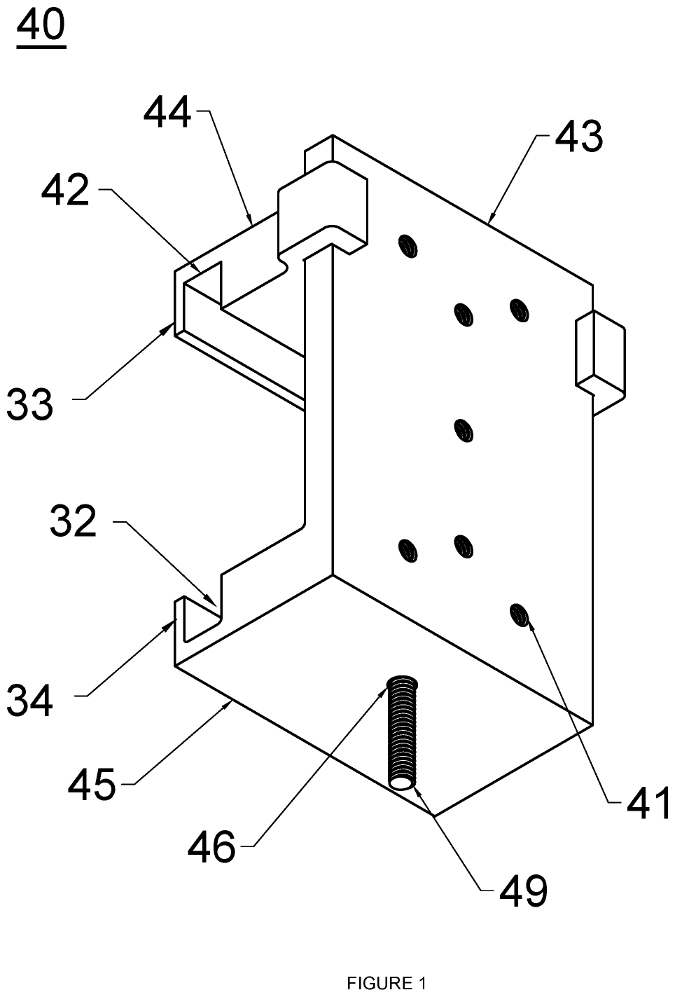

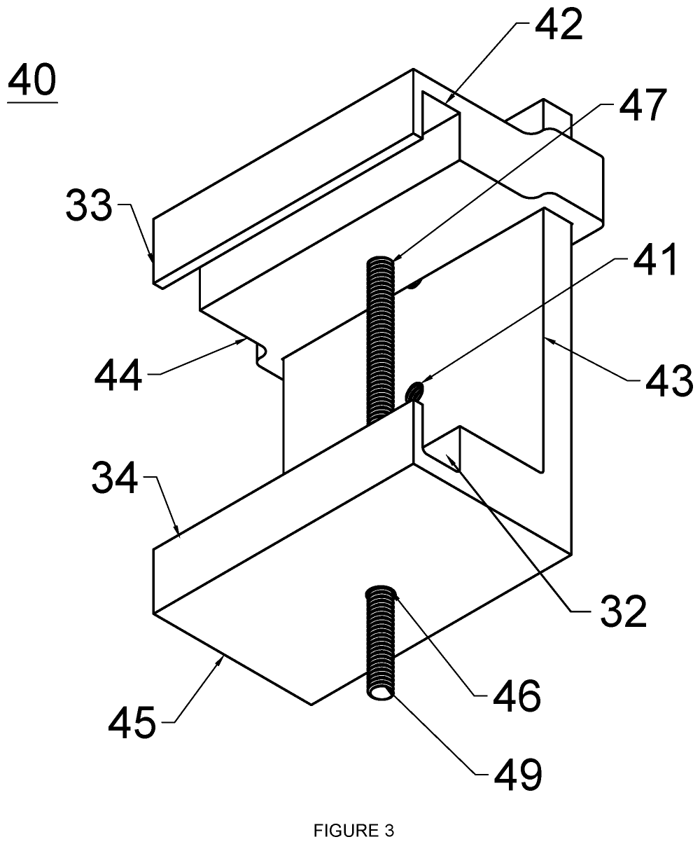

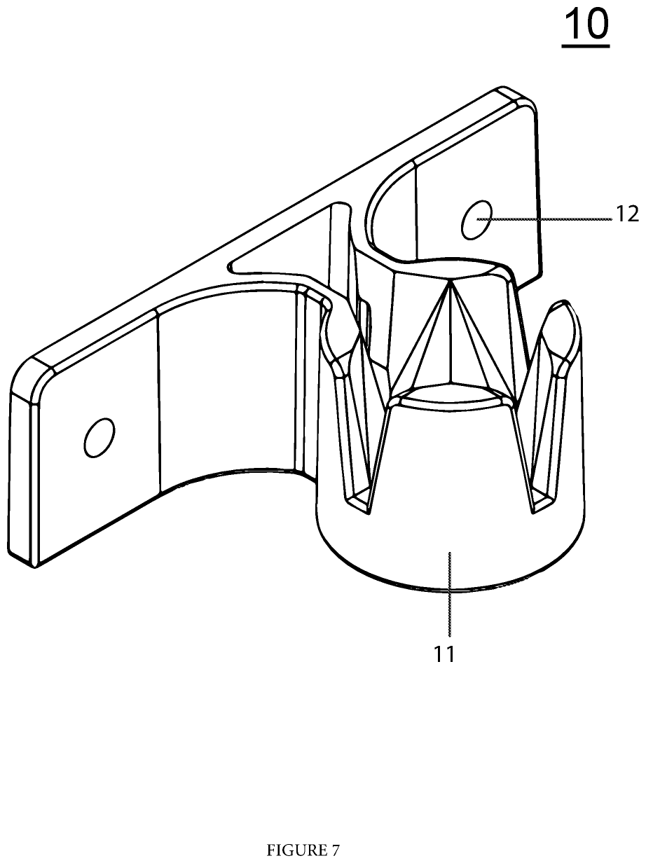

FIG. 1 provides a limited isometric view of the coupler adaptor 40, which is used to construct the aforesaid pipe and drape booths. Because the steel terminal hooks traditionally used on the transverse rods to connect to the vertical member are used in the technology herein to connect to a coupler accessory 11 or other attached accessory, the steel hooks are not illustrated. The coupler adaptor 40 includes features such as the channel openings 32 and 42, channel walls 33 and 34, coupler screwed connections 41, adaptor body 43, slidable clamp 44, stable clamp 45, screw tightener openings 46 and 47 (as illustrated in FIG. 3), screw tightener 49, and an accessory, such as coupler 10 (as illustrated in FIG. 7). Preferably, coupler adaptor 40 will be made from durable reinforced polymer material, ABS plastic, Delrin, polyurethane, or some other suitable material that has sufficient strength and rigidity to effectuate the connection.

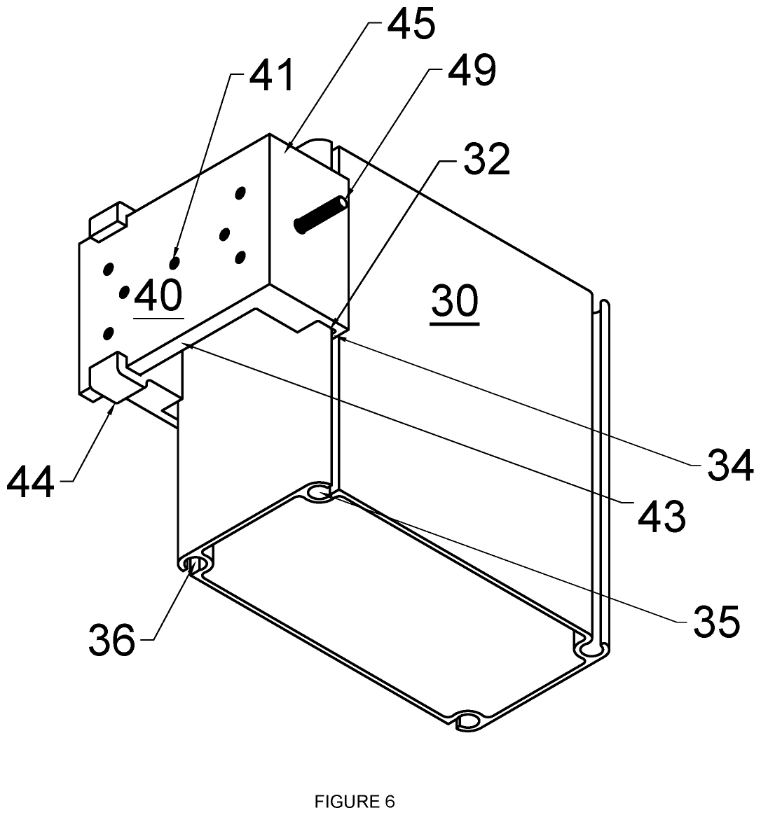

The coupler adaptor 40 clamps onto a vertically configured rectangular extrusion 30, as illustrated in FIG. 6, or other member. The coupler adaptor 40 is placed around the end of the rectangular extrusion with the screw tightener 49 loosened to allow the slidable clamp 44 and the stable clamp 45 to envelop an edge of the rectangular extrusion. The width of the edge of the vertically positioned rectangular extrusion may be any suitable size, such as 1 inch, 2 inches, or 4 inches. The vertically positioned rectangular extrusion may be any suitable type of metal or plastic extrusion, tube, or other similarly rectangular member with edge grooves.

The slidable clamp 44 is slidably affixed to the coupler adaptor body 43. The slidable clamp 44 is oriented perpendicular to the body of the coupler adaptor body 43. The slidable clamp 44 is slidable along the length of the coupler adaptor body 43 from the end of the coupler adaptor body 43 nearest the stable clamp 45 to the opposite end of the coupler adaptor body 43. The stable clamp 45 is affixed to the end of the coupler adaptor body 43 and is typically not slidable. The stable clamp 45 is oriented perpendicular to the body of the coupler adaptor body 43. The slidable clamp 44 is slidably affixed to the coupler adaptor body 43 by a U-shaped channel on opposing ends of the slidable clamp 44 that envelop edges of the coupler adaptor body 43. The slidable claim 44 is thus free to slide along a single axis along the length of the coupler adaptor body 43 but remains upright and perpendicular to the coupler adaptor body 43. In an alternate example, the coupler adaptor 40 has two slidable clamps and does not have a stable clamp. That is, both clamps are slidable and connect similarly to the examples herein.

The slidable clamp 44 and the stable clamp 45 are pulled together along the length of the coupler adaptor body 43 via the screw tightener 49. The screw tightener may be a screwed mechanism that is inserted in the screw tightener opening 46 of the stable clamp 45 and the screw tightener opening 47 (as illustrated in FIG. 3) of the slidable clamp 44. In an example, the screw tightener opening 46 of the stable clamp 45 and the screw tightener opening 47 of the slidable clamp 44 are located substantially in the center of each respective clamp 44, 45. In an example, the screw tightener 49 is slidable into the openings 46, 47, and a fastener, such as a wingnut or threaded nut, is threaded onto the screw tightener 49. The fastener may be screwed onto the screw tightener 49 to pull the slidable clamp 44 and the stable clamp 45 together across the rectangular extrusion. In another example, one or both of the openings 46, 47 are threaded. In this example, the screw tightener 49 is passed slidably through opening 46 and then threaded into the opening 47. As the screw tightener 49 is turned, the slidable clamp 44 and the stable clamp 45 are pulled together. Any other suitable method or mechanism may be used to pull the slidable clamp 44 and the stable clamp 45 together to clamp onto a rectangular extrusion.

The screw tightener 49 may have any suitable head configuration to allow a user to tighten the screw tightener 49. For example, the screw tightener 49 may have a screw drive system to allow tightening with a screwdriver, such as a slot drive or a cross drive. In another example, the screw tightener 49 is configured with a wingnut style drive system to allow a user to turn the screw tightener 49 manually without tools. In another example, the screw tightener 49 has a bolt head, such as a hex bolt or a hex washer head. In this example, a user may tighten the screw tightener 49 with a wrench or a ratcheting socket wrench.

In the alternate example, if both clamps are slidable, when the screw tightener 49 is tightened, both clamps may move toward each other along the length of the coupler adaptor body 43.

When the slidable clamp 44 and the stable clamp 45 are pulled together by the screw tightener 49, the channel openings 32 and 42 and the channel walls 33 and 34 are mated with the grooves on the rectangular extrusion. The channel opening 32 is a rectangular opening extending the vertical length of the stable clamp 45. In an alternate example, the channel opening 32 is another shape, such as cylindrical or hexagonal. The channel wall 34 forms an outer perimeter wall of the channel opening 32. The channel opening 42 is a rectangular opening, or other suitably shaped opening, extending the vertical length of the slidable clamp 44. The channel wall 33 forms an outer perimeter wall of the channel opening 42.

When the coupler adaptor 40 is mounted onto the rectangular extrusion, the channel walls 33, 34 are clamped into the grooves on either side of the rectangular extrusion, as shown in FIG. 6. In an example, the channel wall 34 of the stable clamp 45 is placed into a first corner groove of the rectangular extrusion. The slidable clamp 44 slides to a position along the length of the coupler adaptor body 43 such that the distance between the slidable clamp 44 and the stable clamp 45 is greater than the width of the rectangular extrusion. The screw tightener 49 is tightened to draw the slidable clamp 44 and the stable clamp 45 together until the channel wall 33 of the slidable clamp 44 is forced into the groove on the adjacent corner of the rectangular extrusion. When the channel walls 33, 34 are in the grooves on two adjacent corners of the rectangular extrusion, the edges of the grooves are inserted into the corresponding channel openings 32, 42. That is, the groove edges are inserted into the respective channel openings 32, 42 and the channel walls 33, 34 are inserted into the grooves of the rectangular extrusion. The mating of the channel walls 33, 34 with the grooves forms a solid mount to support the coupler adaptor 40 and any accessories affixed to the coupler adaptor 40. The screw tightener 49 is tightened sufficiently to create a clamped, friction mating with the rectangular extrusion such that the coupler adaptor 40 is securely fastened to the rectangular extrusion to allow the coupler adaptor 40 to support one or more rods or other accessories.

The screwed connections 41 are threaded openings to allow devices, such as a coupler 10 of FIG. 7 with a flat mount connection, to be affixed to the coupler adaptor 40. Any configuration of a connection accessory may be affixed to the coupler adaptor 40 via the screwed connections 41.

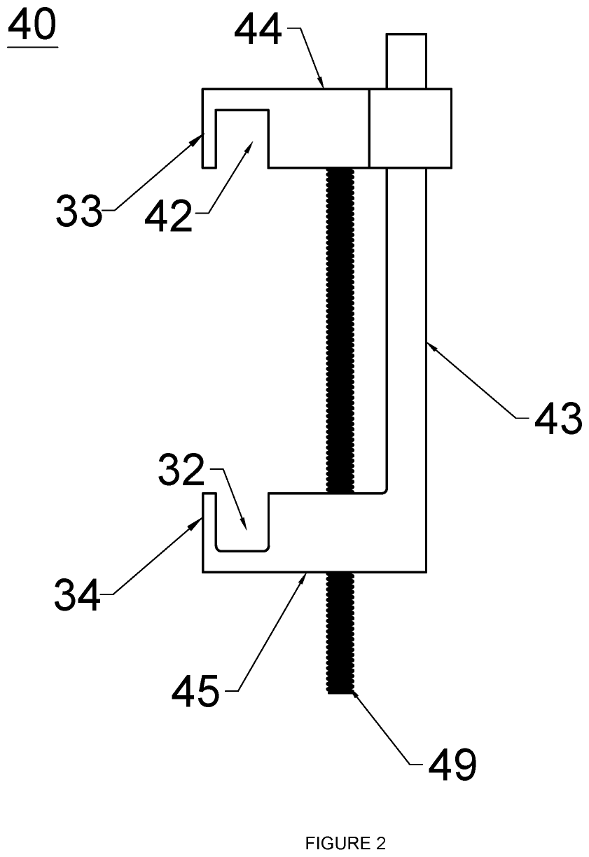

FIG. 2 is a top plan view of one embodiment of the coupler adaptor 40. The illustration of the coupler adaptor 40 includes features such as the channel openings 32 and 42, channel walls 33 and 34, coupler adaptor body 43, coupler slidable clamp 44, coupler stable clamp 45, and screw tightener 49, as described with reference to FIG. 1. The coupler adaptor 40 is illustrated as being closed with the screw tightener 49 extending through the stable clamp 45. In an example, the screw tightener 49 may receive a wingnut or other threaded nut threaded onto the end of the screw tightener 49 to draw the stable clamp 45 and the slidable clamp 44 together. In alternate examples, the stable clamp 45 has a threaded connection and an external wingnut is not required. In alternate examples, the screw tightener 49 is fixed at the stable clamp 45 and extends through the slidable clamp 44. That is, the wingnut may be affixed to the end of the screw tightener 49 that extends through the slidable clamp 44. Any other configuration of screw tightener 49 and nut or other connection may be used.

FIG. 3 is a perspective view of one embodiment of the coupler adaptor 40. The illustration includes features such as the channel openings 32 and 42, channel walls 33 and 34, coupler screwed connections 41, adaptor body 43, slidable clamp 44, stable clamp 45, screw tightener openings 46 and 47, and screw tightener 49, as described with reference to FIG. 1. The coupler adaptor 40 is illustrated as being closed with the screw tightener 49 extending through the stable clamp 45. In an example, the screw tightener 49 may receive a wingnut threaded onto the end of the screw tightener 49 to draw the stable clamp 45 and the slidable clamp 44 together or employ any other connection configuration as discussed herein.

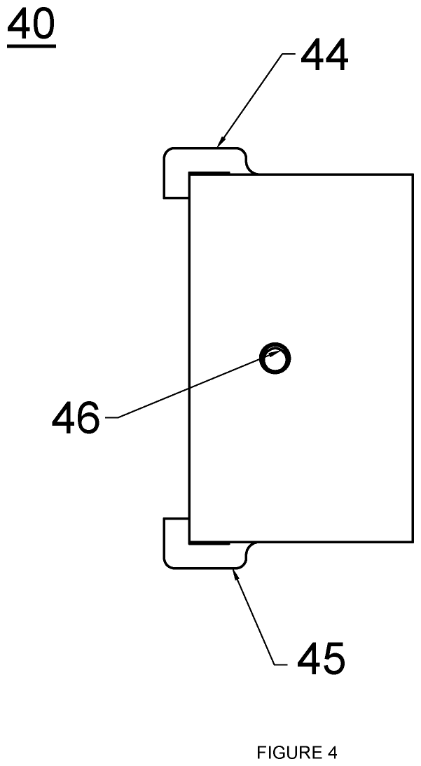

FIG. 4 is a side plan view of one embodiment of the coupler adaptor 40. The illustration includes the slidable clamp 44, the stable clamp 45, and the screw tightener opening 46, as described with reference to FIG. 1.

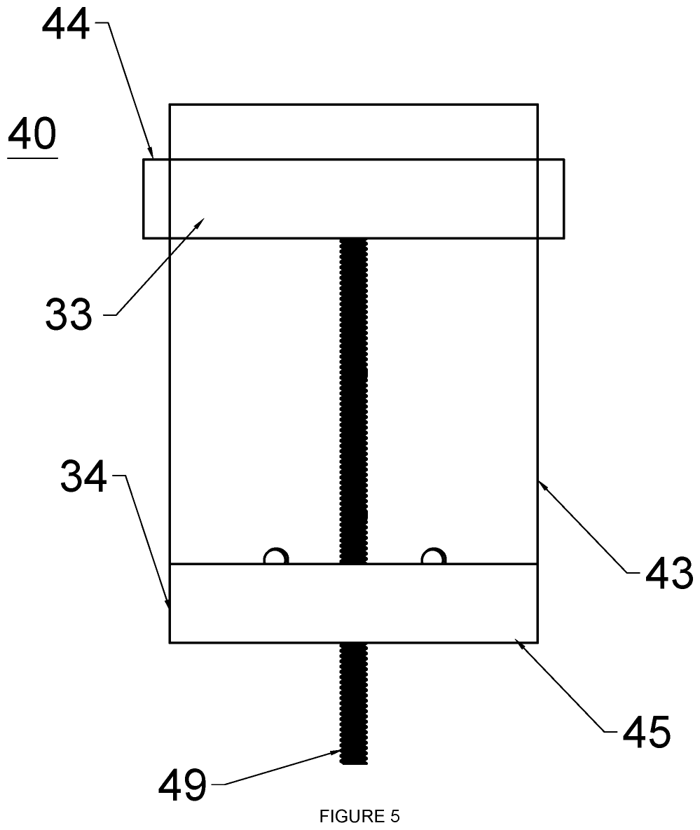

FIG. 5 is a side view of one embodiment of the coupler adaptor 40. The illustration includes features such as the channel walls 33 and 34, coupler adaptor body 43, slidable clamp 44, stable clamp 45, and screw tightener 49, as described with reference to FIG. 1.

FIG. 6 is a perspective view of one embodiment of the coupler adaptor 40 attached to a rectangular extrusion 30. The illustration depicts the coupler adaptor 40, which includes features such as the channel opening 32, channel wall 34, coupler screwed connections 41, coupler adaptor body 43, slidable clamp 44, stable clamp 45, and screw tightener 49, as described with reference to FIG. 1. The coupler adaptor 40 is illustrated as being tightened with the screw tightener 49 extending through the stable clamp 45. In an example, the screw tightener 49 may receive a wingnut threaded onto the end of the screw tightener 49 to draw the stable clamp 45 and the slidable clamp 44 together. As illustrated, when the stable clamp 45 and the slidable clamp 44 are drawn together, the coupler adaptor 40 is mated to the rectangular extrusion 30 such that the coupler adaptor 40 is sufficiently affixed to the rectangular extrusion 30 to allow accessories to be mounted to the coupler adaptor 40. The channel wall 34 is inserted into the groove 35 of the rectangular extrusion 30. The edge of the groove wall is similarly inserted into the channel opening 32. Similarly, the slidable clamp 44 mates with the groove 36 on the adjacent corner of the rectangular extrusion 30. The screw tightener 49 is tightened to create a squeezing force on the rectangular extrusion 30 groove walls. This squeezed mating of the groove 35 and the channel opening 32 allows the coupler adaptor to be suitably affixed to the rectangular extrusion 30.

FIG. 7 is a perspective view of one embodiment of a flat-mounted coupler 10. The illustrated flat-mounted coupler 10 relates to a universal coupler for coupling transverse drape rods to fixed location supports for creating exhibit booths. In an example, the flat-mounted coupler 10 has a castletop style coupler accessory 11 as depicted. The flat-mounted coupler 10 in FIG. 7 relates to a coupler adapted to be affixed via a wall or flat-mounted support. The holes 12 in the flat-mounted coupler mounting may be used to affix the flat-mounted coupler 10 to the screwed connections 41 of the coupler adaptor 40 of FIG. 1.

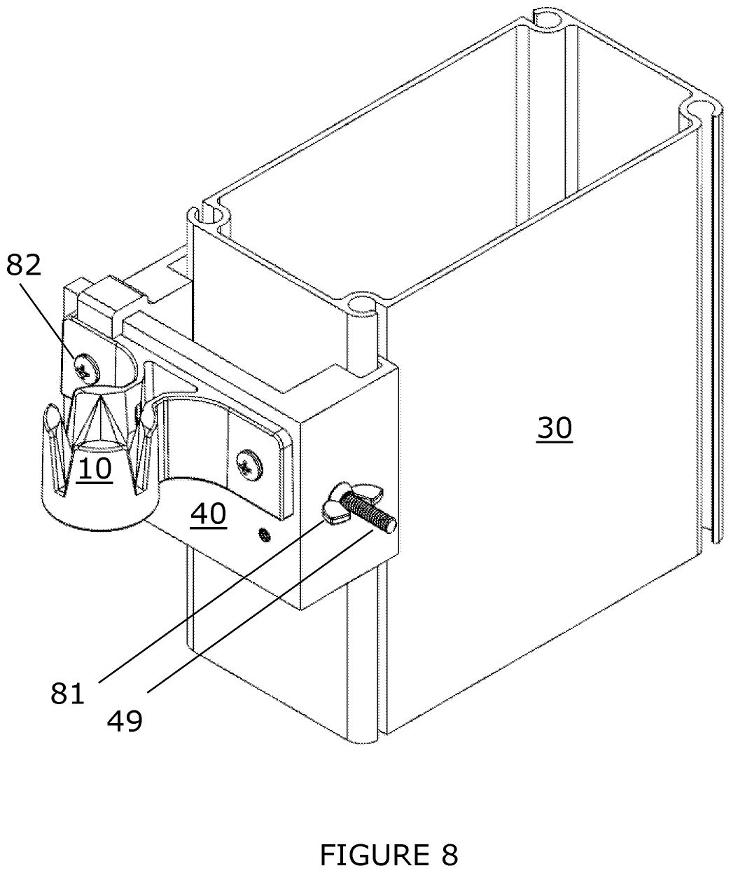

FIG. 8 is a perspective view of one embodiment of the coupler adaptor 40 attached to a rectangular extrusion 30 with a flat-mounted coupler 10. The coupler adaptor 40 is illustrated as clamped onto the rectangular extrusion 30 as described in FIG. 6. The screw tightener 49 is illustrated with a wingnut 81 being used to tighten the coupler adaptor 40 onto the rectangular extrusion 30. As described herein, the wingnut 81 is operable to tighten the slidable clamp 44 and the stable clamp 45, as described with respect to FIG. 1, together to squeeze the coupler adaptor 40 onto the rectangular extrusion 30.

FIG. 8 additionally illustrates a flat-mounted coupler 10 being mounted onto the coupler adaptor 40. The flat-mounted coupler 10, as described with respect to FIG. 7, may be used for coupling transverse drape rods to fixed location supports for creating exhibit booths. The flat-mounted coupler 10 is connected to the coupler adaptor 40 via screws 82 threaded through the screw holes 12, as described with respect to FIG. 7, in the flat-mounted coupler 10 and the screw holes 41, as described with respect to FIG. 1, of the coupler adaptor 40 as depicted herein. The screws 82 may be any type of threaded screws or bolts or other connector that inserts into the screw holes 41 to affix the flat-mounted coupler 10 to the coupler adaptor 40.

What is claimed is:

1. A coupler adaptor to mount to vertical rectangular extrusions, comprising:
a coupler adaptor to support accessories to a vertical-positioned, rectangular extrusion, the coupler adaptor comprising a flat body, a stable clamp, a slidable clamp, a screw tightener, one or more channel openings, and one or more channel walls, wherein the coupler adaptor, when mated with two edge grooves of the rectangular extrusion, is affixed to the rectangular extrusion.

2. The coupler adaptor of claim 1, wherein the slidable clamp is drawn to the stable clamp when the screw tightener is engaged.

3. The coupler adaptor of claim 2, wherein the screw tightener is engaged by a threaded nut.

4. The coupler adaptor of claim 2, wherein when the screw tightener is engaged, the coupler adapter creates a clamped, friction mating with the rectangular extrusion.

5. The coupler adaptor of claim 1, wherein the coupler adaptor flat body has screwed connections with which to affix couplers.

6. The coupler adaptor of claim 1, wherein the coupler adaptor is mated to the rectangular extrusion when each of the one or more channel walls is inserted into a respective one of the two edge grooves.

7. The coupler adaptor of claim 1, wherein an opening of the stable clamp is threaded to receive the screw tightener.

8. The coupler adaptor of claim 1, wherein an opening of the slidable clamp is threaded to receive the screw tightener.

9. The coupler adaptor of claim 1, wherein the channel openings are rectangular.

10. The coupler adaptor of claim 1, wherein the slidable clamp is slidable along a length of the coupler adaptor from an end of the coupler adaptor nearest the stable clamp to an opposite end of the coupler adaptor.

11. The coupler adaptor of claim 1, further comprising a flat-mounted coupler that is screwed to the flat body of the coupler adaptor.

12. The coupler adaptor of claim 11, wherein the flat-mounted coupler comprises a castletop style coupler.

13. The coupler adaptor of claim 11, wherein the flat-mounted coupler comprises two or more couplers mounted on connection bridges from a body of the flat-mounted coupler.

14. A method to mount a coupler adaptor to vertical rectangular extrusions, comprising:
affixing a coupler adaptor to support accessories to a vertical-positioned, substantially rectangular extrusion, the coupler adaptor comprising a flat body, a stable clamp, a slidable clamp, a screw tightener, one or more channel openings, and one or more channel walls, wherein the coupler adaptor, when mated with two edge grooves of the rectangular extrusion, is affixed to the rectangular extrusion.

15. The method of claim 14, wherein the slidable clamp is drawn to the stable clamp when the screw tightener is engaged.

16. The method of claim 14, further comprising threading a threaded nut onto the screw tightener to draw the slidable claim to the stable clamp. The method of claim 14, further comprising affixing couplers to the flat body by inserting screws into screw holes in the flat body.

18. The method of claim 14, wherein the coupler adaptor is mated to the rectangular extrusion when each of the one or more channel walls is inserted into a respective one of the two edge grooves.
